(19) United States
(12) Patent Application Publication
(10) Pub. No.: US 2018/0186155 A1
(43) Pub. Date: Jul. 5, 2018

(54) THERMAL HEAD FOR PRINTER

(71) Applicant: SATO HOLDINGS KABUSHIKI KAISHA, Tokyo (JP)

(72) Inventor: Kazuyuki HOSHI, Saitama (JP)

(73) Assignee: SATO HOLDINGS KABUSHIKI KAISHA, Tokyo (JP)

(21) Appl. No.: 15/907,890

(22) Filed: Feb. 28, 2018

(51) Int. Cl. B41J 2/335

(52) U.S. Cl. CPC B41J 2/3352; B41J 2/33515; B41J 2/33575

(57) ABSTRACT

A printer includes a thermal head, an electrical connector capable of being connected to and disconnected from the thermal head, and a head cover of the thermal head. The head cover moves between a first position and a second position different from the first position to connect and a disconnect the thermal head and the electrical connector.

### BACKGROUND OF THE INVENTION

The present invention relates to thermal heads for printers.

A thermal printer prints information on labels typically, and includes a thermal head. Since the thermal head is a consumable, it needs replacing.

When the thermal head is replaced, electrical connections between the thermal head and the controlling electronics in the printer are disconnected and reconnected by hand.

### SUMMARY OF THE INVENTION

The inventors have realized that problems occur in making the electrical connections between the thermal head and the controlling electronics in the printer. The electrical connectors from the controlling electronics are at the ends of wires from the printer. The electrical connections between the thermal head and the controlling electronics must be disconnected and reconnected by hand. The space for inserting hands and fingers to accomplish the disconnection and reconnection is limited and thus the disconnection and reconnection procedure is difficult and time consuming. Also, the user may not know the correct amount of force to use in making the disconnection and reconnection, and thus it is easy for the user to apply excessive force and damage the electrical connections.

Also, users of a thermal printer are often unfamiliar with the replacement of a thermal head. For such users, the replacement of a thermal head is a burden.

The present subject matter aims to facilitate and improve the replacement of a thermal head.

According to one embodiment, a thermal head for a printer comprises a heater element configured to print information; and a male electrical connector configured to mate with a female electrical connector which moves in response to movement of a thermal head cover.

According to another embodiment, a thermal head for a printer comprises a heater element configured to print information; and a female electrical connector configured to mate with a male electrical connector which moves in response to movement of a thermal head cover.

### BRIEF DESCRIPTION OF THE DRAWINGS

FIG. 1 schematically describes a print medium of the present embodiment.

FIG. 2 is a perspective view of a thermal head, head bracket and connector unit.

FIGS. 3A and 3B show a major part of a connector unit of FIG. 2.

FIGS. 4A and 4B are perspective views of a major part of a thermal head of FIG. 2.

FIG. 5 is a side view of the major parts of the head bracket of FIG. 2, the connector unit of FIG. 3, and the thermal head of FIG. 4.

FIG. 6 schematically shows the feed path of the present embodiment.

FIGS. 7A and 7B are cross-sectional views showing the thermal head of the present embodiment before connecting to the connector unit.

FIG. 8 is a side view of a major part of the opening and closing cover corresponding to FIG. 7.

FIGS. 9A and 9B are cross-sectional views of the present embodiment when the head cover moves from the non-shielding position of FIG. 8 to the shielding position of FIG. 10.

FIG. 10 is a side view of a major part of the opening and closing cover when the head cover of the present embodiment is at a shielding position.

FIGS. 11A and 11B are cross-sectional views showing the thermal head of the present embodiment when connecting to the connector unit.

FIGS. 12A and 12B show movement when the head cover moves from the shielding position of FIG. 10 to the non-shielding position of FIG. 8.

FIG. 13 schematically shows a modified example of the present embodiment.

FIG. 14 is a top perspective view of another embodiment.

FIG. 15 is a rear perspective view of the design of FIG. 14.

FIG. 16 is a bottom perspective view of the design of FIG. 14.

FIG. 17 is a front view of the design of FIG. 14.

FIG. 18 is a rear view of the design of FIG. 14.

FIG. 19 is a left side view of the design of FIG. 14.

FIG. 20 is a right side view of the design of FIG. 14.

FIG. 21 is a top view of the design of FIG. 14.

FIG. 22 is a bottom view of the design of FIG. 14.

### DETAILED DESCRIPTION OF EMBODIMENTS OF THE INVENTION

The following describes embodiments of the invention.

The following describes embodiments of the present invention in detail, with reference to the drawings. In the drawings describing the embodiments, like numbers indicate like components, and their repeated description is omitted.

In the following description, “FR” refers to the front of a printer and “RR” refers to the rear of the printer.

“UP” refers to the upward when the printer is placed on a horizontal plane, and “LO” refers to the downward when the printer is placed on a horizontal plane.

“LH” and “RH” refer to the direction (hereinafter called a “width direction”) orthogonal to the front-rear direction and the up-down direction of the printer.

A part of the printer closer to the container than any referential position on the feed path is referred to the part located “upstream in the feeding direction”. A part of the printer closer to the ejection port than the referential position is referred to the part located “downstream in the feeding direction”.

### (1) PRINT MEDIUM

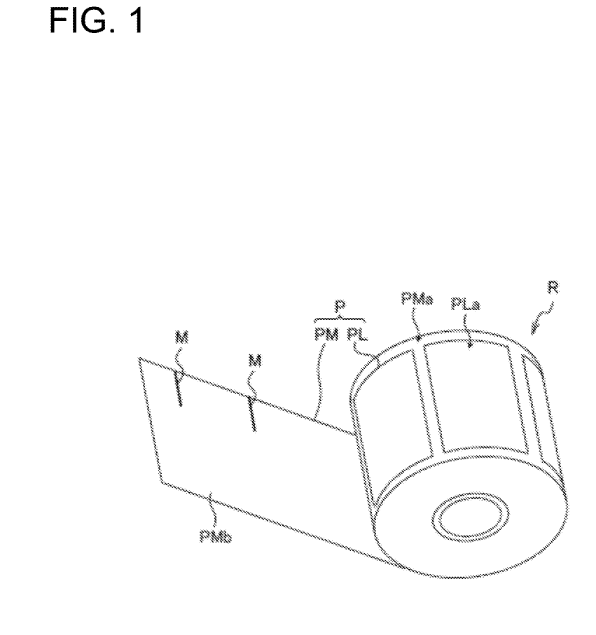

The following describes a print medium of the present embodiment. FIG. 1 schematically describes a print medium of the present embodiment.

As shown in FIG. 1, a print medium P of the present embodiment includes a liner PM and a plurality of labels PL.

The liner PM includes a temporary-adhesive face PMa and a non-temporary-adhesive face PMb on the other side of the temporary-adhesive face PMa.

The plurality of labels PL temporarily adheres to the temporary-adhesive face PMa at predetermined intervals.

On the non-temporary-adhesive face PMb, reference marks M are formed at predetermined intervals. A reference mark M shows the reference position for a label PL.

Each label PL has a print surface PLa and a sticking surface PLb (not illustrated).

The print surface PLa includes a thermosensitive layer that develops a color by heat.

On the sticking surface PLb, adhesive is applied.

### (2) CONFIGURATION OF PRINTER

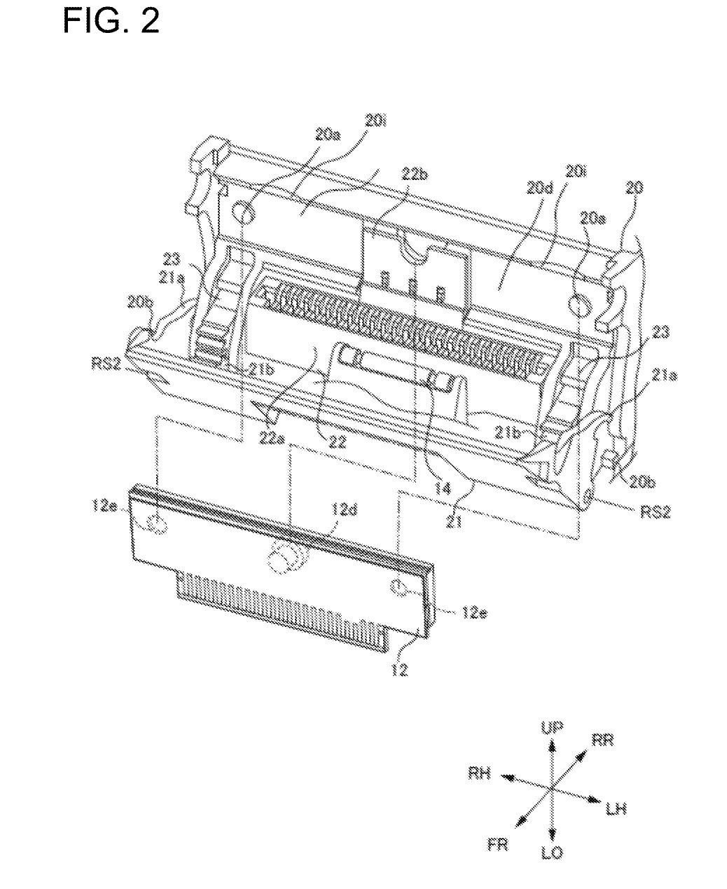

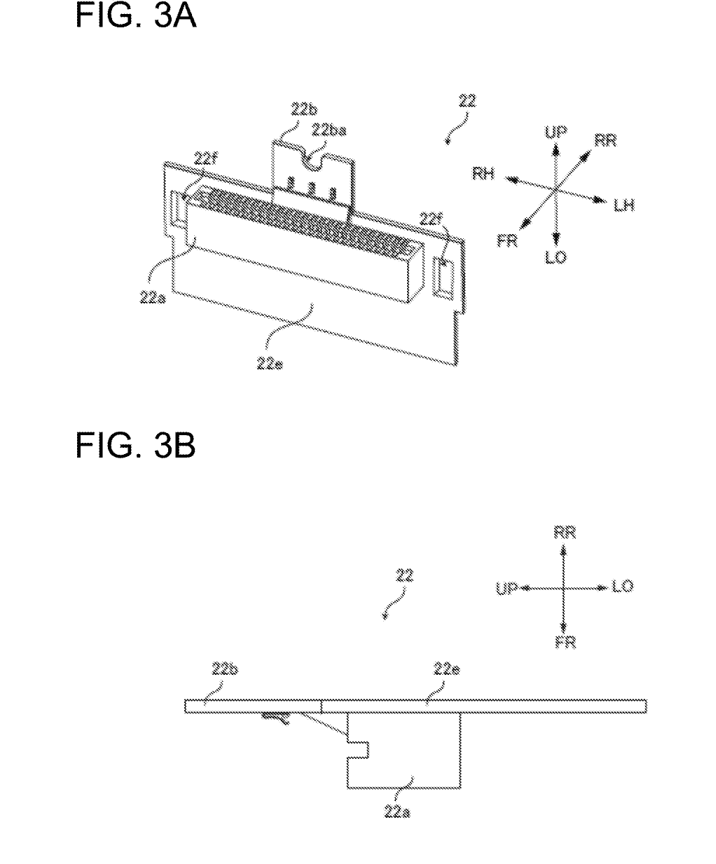

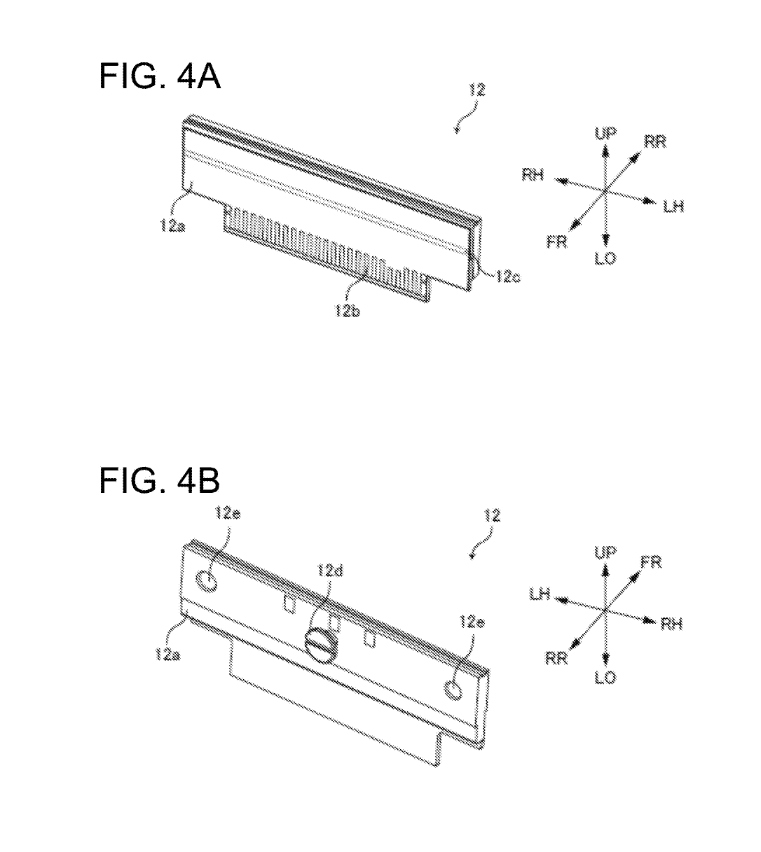

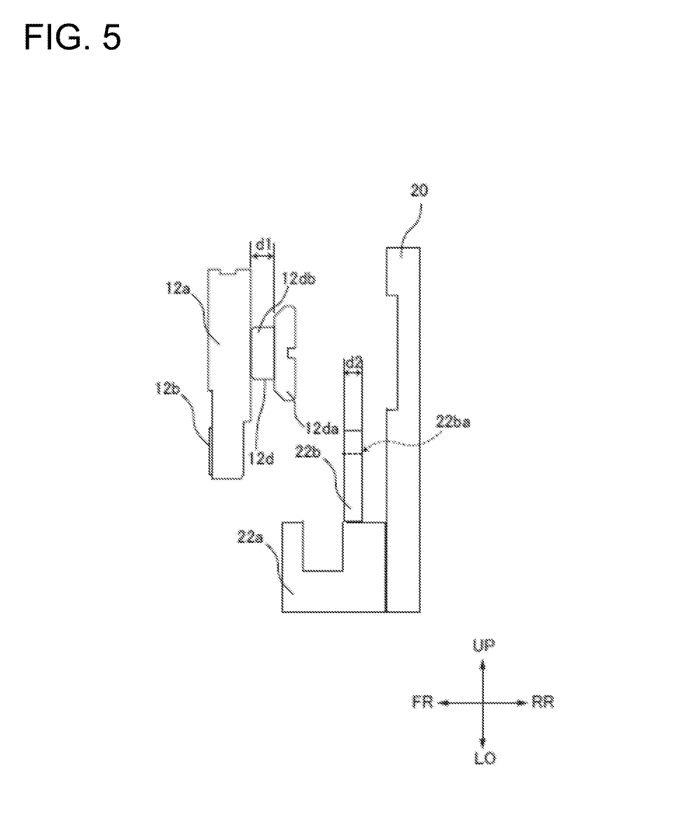

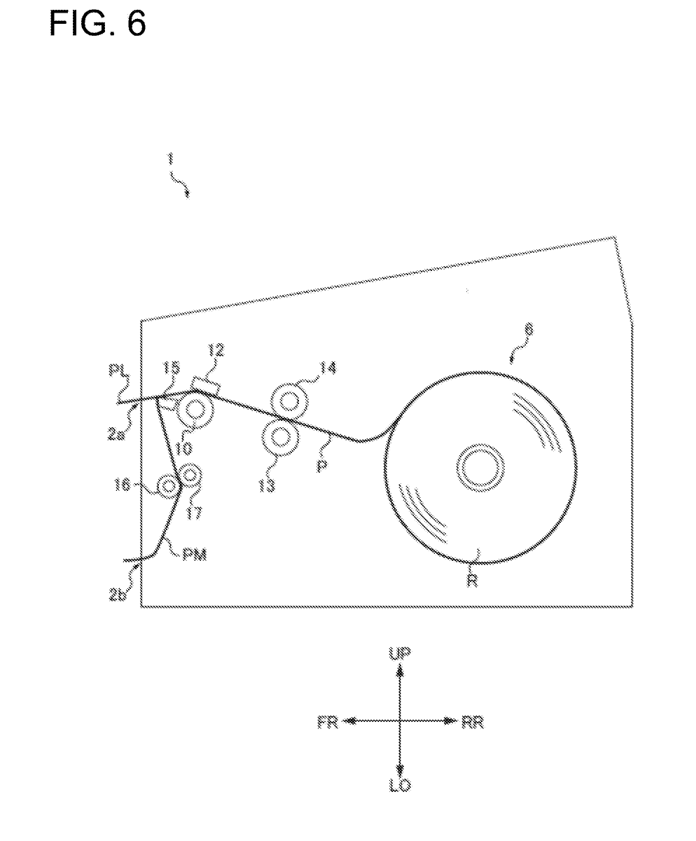

FIG. 2 is a perspective view of a thermal head 12, a head bracket 20 and a connector unit 22 of a printer 1 (shown in FIG. 6). FIG. 3 shows a major part of connector unit 22 of FIG. 2. FIG. 4 is a perspective view of a major part of thermal head 12 of FIG. 2. FIG. 5 is a side view of the major parts of the head bracket 20 of FIG. 2, the connector unit 22 of FIG. 3, and the thermal head 12 of FIG. 4.

As shown in FIGS. 2 and 6, the printer 1 includes the thermal head 12, a second assisting roller 14, the head bracket 20, a head cover 21, the connector unit 22 (one example of a connecting part) and a pair of gears 23.

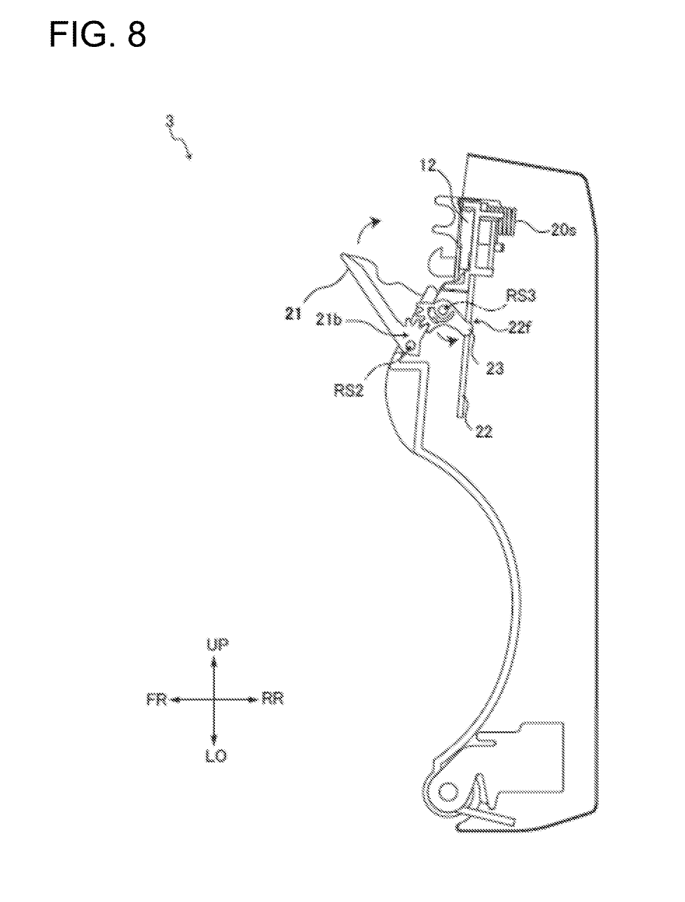

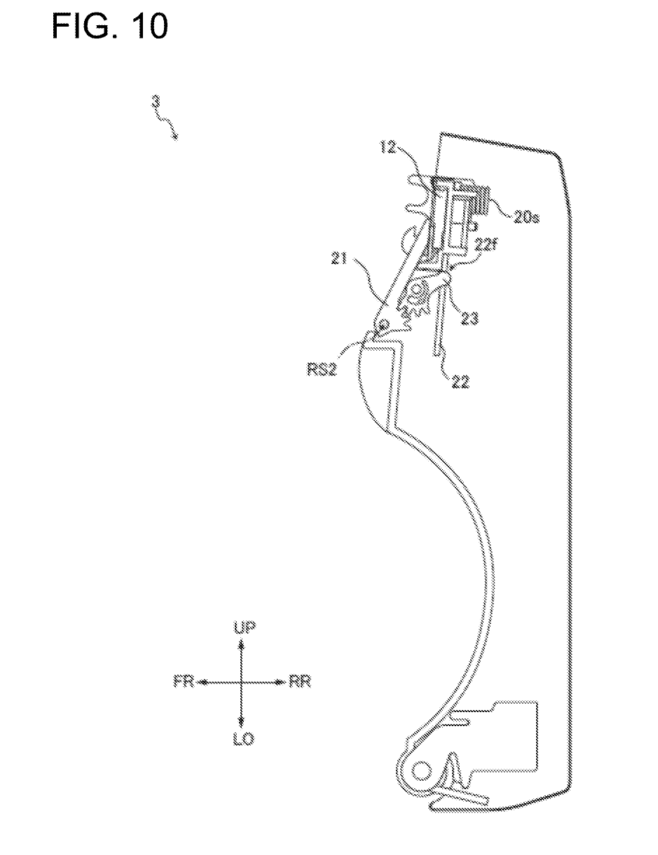

The head cover 21 is pivotally supported. The head cover 21 can move (i.e., can rotate) a relative to a printer cover 3 (shown in FIGS. 8 and 10) between a shielding position (one example of a first position) and a non-shielding position (one example of a second position) about a rotary axis RS2.

The head cover 21 at the shielding position shields a part of the thermal head 12. In this case, a part of the thermal head 12 and the connector unit 22 are covered by the head cover 21, and therefore they cannot be seen from the outside of the printer 1.

The head cover 21 at the non-shielding position opens the connector unit 22. Specifically a space is defined between the head cover 21 at the non-shielding position and the printer cover 3. The connector unit 22 is exposed through this space. The connector unit 22 has a connector 22a (described later) as a connecting terminal, and the connector 22a is directed upward (UP). In this case, the thermal head 12 and the connector unit 22 can be seen from the outside of the printer 1.

The second assisting roller 14 is rotatably supported at the printer cover 3.

The second assisting roller 14 assists the feeding of the print medium P while rotating following the rotation of a first assisting roller 13.

As shown in FIG. 2, the head bracket 20 includes a pair of convexes 20a, a pair of protrusions 20b and a head bracket body 20d.

The pair of convexes 20a protrudes forward (FR) from the head bracket body 20d.

The head cover 21 includes a pair of engaging parts 21a and a pair of gears 21b.

The pair of engaging parts 21a is located at lateral ends of the head cover 21.

The pair of engaging parts 21a engages with the pair of protrusions 20b so as to lock the head cover 21 at the shielding position.

When a user rotates the head cover 21, the engagement between the pair of engaging parts 21a and the pair of protrusions 20b is canceled.

As shown in FIGS. 3A and 3B, the connector unit 22 has a front face. On the front face, the female connector 22a (one example of a second connector), an abutting part 22b, a connector board 22e, and a pair of engagement holes 22f are disposed. Abutting part 22b, including notch 22ba (discussed below), is formed on an extended portion of the connector board 22e.

The connector 22a is disposed on the front face of the connector board 22e.

The abutting part 22b protrudes upward (UP) from the upper end of the connector board 22e. The abutting part 22b has notch 22ba. The notch 22ba is at a center of the connector unit 22 in the width direction (LH-RH direction).

As shown in FIG. 2, the pair of gears 23 engages with the pair of engagement holes 22f and the pair of gears 21b. Such engagement converts the rotary motion of the head cover 21 into the motion of the connector unit 22 in the up-down direction (UP-LO direction) via the pair of gears 23.

That is, a gear mechanism is made up of the pair of gears 21b and the pair of gears 23, and this gear mechanism is a moving mechanism to join with the connector unit 22 and with the head cover 21. As the head cover 21 is moved, this moving mechanism moves the connector unit 22 (e.g., slides it in the up-down direction (UP-LO direction)) for connection and disconnection of the thermal head 12 and the connector unit 22.

The thermal head 12 can be connected to and disconnected from the connector unit 22.

As shown in FIG. 4A, the thermal head 12 has a front face. On the front face, a thermal head body 12a, a male connector 12b (one example of a first connector), and a plurality of heater elements 12c are disposed.

As shown in FIG. 4B, the thermal head 12 has a rear face. On the rear face, a connector unit limiter 12d (one example of a connection position limiter, which limits a position of the connector 12b relative to the printer, for example, in a direction orthogonal to the moving direction) and a pair of concaves 12e are disposed.

The connector 12b protrudes downward (LO) from the thermal head body 12a. The connector 12b is at a center of the thermal head 12 in the width direction (LH-RH direction).

The plurality of heater elements 12c is located above (UP) the connector 12b. The plurality of heater elements 12c is aligned along the width direction (LH-RH direction) of the thermal head 12. This aligning direction of the plurality of heater elements 12c is called a “print line direction”.

The pair of concaves 12e is located on opposite sides (outboard) of the connector unit limiter 12d in the width direction (LH-RH direction).

The connector unit limiter 12d protrudes rearward (RR) from the rear face of the thermal head body 12a.

As shown in FIG. 5, the connector unit limiter 12d includes a first limiter 12da and a second limiter 12db.

The second limiter 12db protrudes rearward (RR) from the rear face of the thermal head body 12a.

The second limiter 12db joins with the thermal head body 12a and with the first limiter 12da.

The size d1 of the second limiter 12db is substantially the same as the size d2 of the notch 22ba in the front-rear direction (FR-RR direction).

The connector unit 22 can be connected to and disconnected from the thermal head 12. Connecting of the connector unit 22 to the thermal head 12 establishes a connection of the thermal head 12 to a control circuit (not illustrated).

### (3) FEED PATH

The following describes a feed path of the present embodiment. FIG. 6 schematically shows the feed path of the present embodiment.

As shown in FIG. 6, the feed path of the print medium P is a path between a container 6 and a separator 15. The feed path of the print medium P extends through the first assisting roller 13, the second assisting roller 14, the thermal head 12 and a platen roller 10.

The feed path of the labels PL is a path between the separator 15 and a label ejection port 2a.

The feed path of the liner PM is a path between the separator 15 and a liner ejection port 2b. The feed path of the liner PM extends through a first nip roller 16 and a second nip roller 17.

The container 6 contains a roll of paper R.

The first assisting roller 13 and the second assisting roller 14 are located downstream of the container 6 in the feeding direction. The first assisting roller 13 is located under (LO) the feed path. The second assisting roller 14 is located above (UP) the feed path. That is, when the printer cover 3 is at the closed position, the first assisting roller 13 and the second assisting roller 14 are opposed.

The first assisting roller 13 is connected to a stepping motor. The first assisting roller 13 rotates under the control of the stepping motor.

The second assisting roller 14 rotates following the rotation of the first assisting roller 13.

The first assisting roller 13 and the second assisting roller 14 rotate while keeping the print medium P there between so as to assist the feeding of the print medium P.

The platen roller 10 and the thermal head 12 are located downstream of the first assisting roller 13 and the second assisting roller 14 in the feeding direction. The platen roller 10 is located below (LO) the feed path.

The thermal head 12 is located above (UP) the feed path. That is, when the printer cover 3 is at the closed position, the platen roller 10 and the thermal head 12 are opposed.

The separator 15 is located downstream of the platen roller 10 and the thermal head 12 in the feeding direction.

The upper face and the front face of the separator 15 define a sharp angle.

The first nip roller 16 and the second nip roller 17 are located downstream of the separator 15 in the feeding direction. The first nip roller 16 and the second nip roller 17 are opposed.

The first nip roller 16 rotates following the rotation of the second nip roller 17.

The second nip roller 17 is connected to a stepping motor. The second nip roller 17 rotates under the control of the stepping motor.

The first nip roller 16 and the second nip roller 17 rotate while keeping the liner PM there between so as to feed the liner PM from the separator 15 to the liner ejection port 2b.

As the platen roller 10 rotates forward (counterclockwise in FIG. 6), a belt-like print medium P (the combination of labels PL and liners PM) is extracted from the container 6 to the downstream of the container 6 in the feeding direction. The lower face of the extracted print medium P is the non-temporary-adhesive face PMb of the liner PM. The upper face of the extracted print medium P is the print surface PLa.

As the platen roller 10 rotates forward, the first assisting roller 13 rotates counterclockwise in FIG. 6 while having a contact with the non-temporary-adhesive face PMb. At the same time, the second assisting roller 14 rotates clockwise in FIG. 6 while having a contact with the print surface PLa.

The control circuit receives print data corresponding to information to be printed on the print surface PLa (hereinafter called “print information”) in response to a user's instruction. The control circuit controls the heater elements to generate heat in accordance with the print data.

When the print medium P passes through between the thermal head 12 and the platen roller 10, the heater elements generating heat are pressed against the print surface PLa. Due to the heat of the heater elements, the thermosensitive layer at the print surface PLa develops a color. As a result, print information (such as a bar code) is printed on the print surface PLa.

The label PL is fed from the front end of the separator 15 to the label ejection port 2a.

The liner PM along the front face of the separator 15 is folded back downward (LO) and rearward (RR), and then is fed toward the liner ejection port 2b.

In other words, the separator 15 folds back the liner PM at a sharp angle relative to the label PL. As a result, the separator 15 separates the label PL from the liner PM.

The label PL separated from the liner PM is ejected from the label ejection port 2a.

The liner PM after the label PL is separated (i.e., the liner PM passing through the front end of the separator 15) passes through between the first nip roller 16 and the second nip roller 17, and then is ejected from the liner ejection port 2b.

### (4) CONNECTING AND DISCONNECTING OF THERMAL HEAD AND CONNECTOR UNIT

The following describes connecting and disconnecting of the thermal head and the connector unit of the present embodiment.

(4-1) Connecting of Thermal Head to Connector Unit

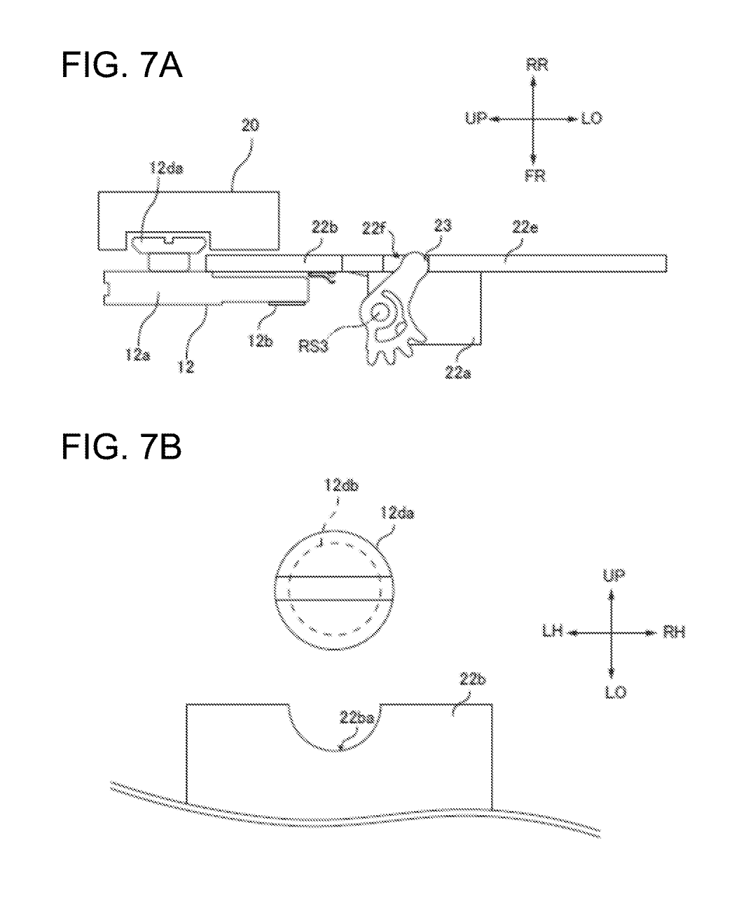

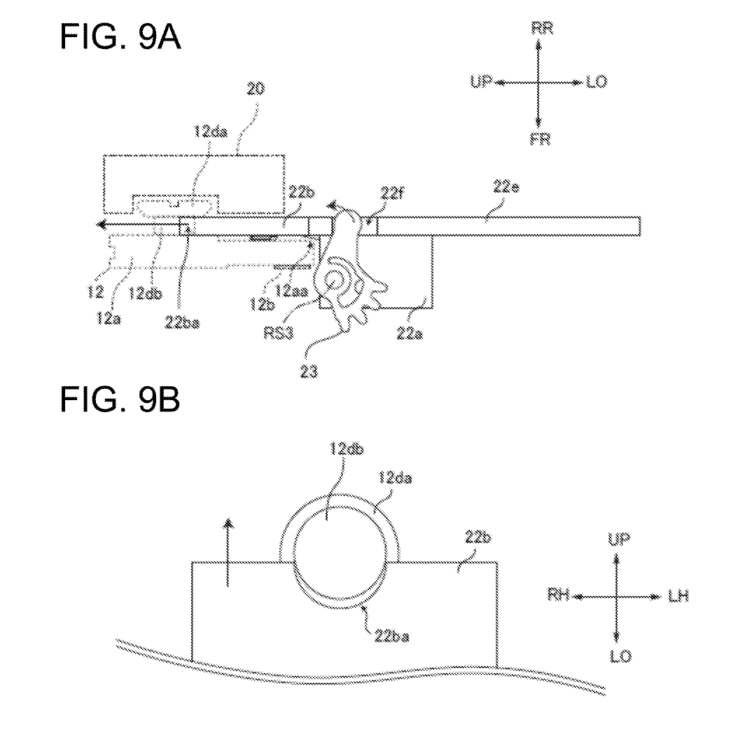

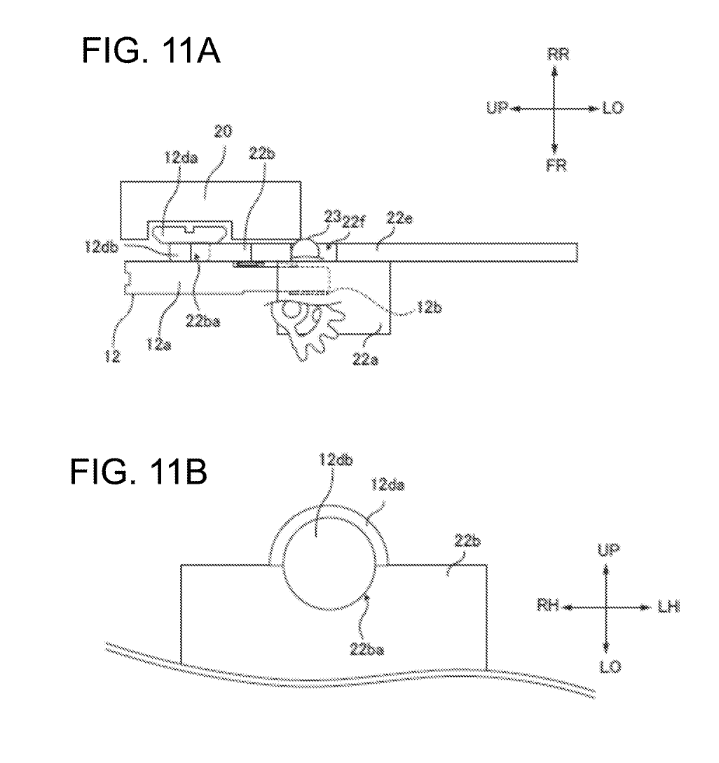

The following describes connecting of the thermal head to the connector unit of the present embodiment. FIG. 7 is a cross-sectional view showing the thermal head of the present embodiment before connecting to the connector unit. FIG. 8 is a side view of a major part of the opening and closing cover corresponding to FIG. 7. FIG. 9 is a cross-sectional view of the head cover of the present embodiment when the head cover moves from the non-shielding position of FIG. 8 to the shielding position of FIG. 10. FIG. 10 is a side view of a major part of the opening and closing cover when the head cover of the present embodiment is at a shielding position. FIG. 11 is a cross-sectional view showing the thermal head of the present embodiment when connecting to the connector unit.

Before connecting the thermal head 12 to the connector unit 22, a user sets the head cover 21 at the non-shielding position.

Next, as shown in FIG. 2, the user attaches the thermal head 12 to the head bracket 20. Specifically the user fits the pair of concaves 12e with the pair of convexes 20a. This holds the thermal head 12. That is, the pair of concaves 12e and the pair of convexes 20a function as a holding part to hold the thermal head 12. The pair of concaves 12e (two depressions) are configured to receive convexes 20a (two projections) of the head bracket 20 to restrict the thermal head 12 from moving in a feeding direction of print medium P. The printer cover 3 is configured to hold the thermal head 12 via the head bracket 20.

Instead of the concaves 12e and the convexes 20a, convexes at the thermal head 12 and concaves at the head bracket 20 may hold the thermal head 12.

The abutting part 22b extends parallel to the connector 12b of the held thermal head 12.

As shown in FIG. 8, when the user rotates the head cover 21 clockwise (i.e., in the opposite direction of the rotating direction of the printer cover 3 when it rotates from the open position to the closed position) around the rotary axis RS2, the gears 23 rotate counterclockwise around the rotary axis RS3 with the rotation of the head cover 21.

As shown in FIG. 9A, each gear 23 rotates counterclockwise while having a contact with the upper end of the engagement hole 22f.

As shown in FIG. 9B, as the gears 23 rotate, the connector unit 22 moves upward (UP) (i.e., in the direction toward the thermal head 12 held by the head bracket 20).

As shown in FIG. 9B, as the gears 23 rotate, the abutting part 22b moves upward (UP).

At this time, the abutting part 22b comes into contact with the outer periphery of the second limiter 12db. Specifically the connector unit 22 moves while having its notch 22ba engaging with the connector unit limiter 12d. This can limit the position of the connector unit 22 in the up-down direction (UP-LO direction) during connection and disconnection of the connector unit 22 and the thermal head 12.

As shown in FIG. 5, the size d1 of the second limiter 12db is substantially the same as the size d2 of the notch 22ba in the front-rear direction (FR-RR direction).

When the notch 22ba engages with the second limiter 12db, the front face of the notch 22ba comes into contact with the rear face of the thermal head body 12a and the rear face of the notch 22ba comes into contact with the front face of the first limiter 12da. This enables the positioning of the connector unit 22 in the front-rear direction (FR-RR direction).

That is, the first limiter 12da limits the position of the connector unit 22 in the front-rear direction (FR-RR direction). When the thermal head 12 is inserted, the first limiter 12da may be adjacent to the head bracket 20 and thus at least partially or momentarily contact the head bracket 20.

The notch 22ba engaging with the second limiter 12db supports the lower face and the outer periphery of the second limiter 12db. This enables the positioning of the connector unit 22 in the up-down direction (UP-LO direction) and in the width direction (LH-RH direction). That is, the second limiter 12db limits the position of the connector unit 22 in the moving direction (UP-LO direction) and in the width direction (LH-RH direction).

In this way, the engagement of the notch 22ba with the second limiter 12db enables the positioning of the connector unit 22. As a result, the connector unit 22 can move in parallel with the thermal head 12.

That is, the second limiter 12db and the abutting part 22b limit the position of the thermal a head 12 in the moving direction (UP-LO direction) of the connector unit 22 and in the directions (FR-RR direction and LH-RH direction) orthogonal to the moving direction (UP-LO direction) of the connector unit 22.

The head bracket 20 has a front face. This front face has a concave to which the first limiter 12da retracts.

The second limiter 12db and the abutting part 22b may limit the position of the thermal head 12 in the moving direction (UP-LO direction) of the connector unit 22 only. In this case, the position of the thermal head 12 is not limited in the directions (FR-RR direction and LH-RH direction) orthogonal to the moving direction (UP-LO direction) of the connector unit 22. That is, the thermal head 12 and the connector unit 22 have a clearance there between in the directions (FR-RR direction and LH-RH direction) orthogonal to the moving direction (UP-LO direction) of the connector unit 22.

As shown in FIG. 10, when the head cover 21 reaches the shielding position, the connector 12b connects to the connector 22a as shown in FIG. 11A.

The pair of engaging parts 21a of FIG. 2 engages with the pair of protrusions 20b. This engagement functions as a locking part to lock the head cover 21 at the shielding position. This locks the connection of the thermal head 12 to the connector unit 22 as well.

As shown in FIG. 11B, the notch 22ba engages with a part of the second limiter 12db. This can fix the position of the connector unit 22 connected to the thermal head 12.

(4-2) Disconnecting of Thermal Head from Connector Unit

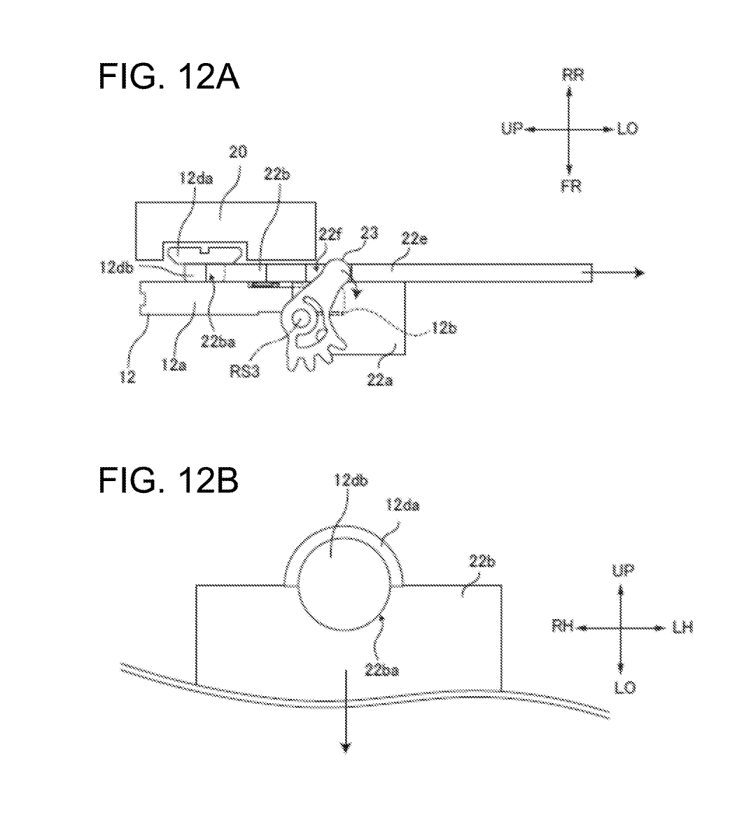

The following describes disconnecting of the thermal head from the connector unit of the present embodiment. FIG. 12 shows the present embodiment when the head cover moves from the shielding position of FIG. 10 to the non-shielding position of FIG. 8.

In order to disconnect the thermal head 12 from the connector unit 22, the user rotates the head cover 21 counterclockwise in FIG. 10 (i.e., in the opposite direction of the rotating direction of the printer cover 3 when it rotates from the closed position to the open position) around the rotary axis RS2. Then the head cover 21 moves from the shielding position (FIG. 10) to the non-shielding position (FIG. 8) with the rotation.

As shown in FIG. 12A, each gear 23 rotates clockwise while having a contact with the lower end of the engagement hole 22f.

As shown in FIG. 12B, as the gears 23 rotate, the connector unit 22 moves downward (LO) (i.e., in the direction away from the thermal head 12 held by the head bracket 20). This disconnects the thermal head 12 from the connector unit 22.

### (5) SUMMARY OF EMBODIMENT

The following is a summary of the present embodiment.

As described above, when the user moves the head cover 21 of the present embodiment, connecting or disconnecting of the connector 12b as the connecting terminal of the thermal head 12 and the connector 22a as the connecting terminal of the printer body occurs. That is, the user can connect or disconnect the thermal head 12 and the connector unit 22 without touching the thermal head 12 and the connector unit 22. This facilitates the connecting and disconnecting of the thermal head 12 and the connector unit 22.

When a user touches the thermal head 12, dirt may adhere to the thermal head 12. Such dirt may cause malfunction of the thermal head 12. According to the present embodiment, after attaching the thermal head 12 to the head bracket 20 for holding, a user need not touch the thermal head 12. This can suppress adherence of dirt to the thermal head 12.

According to the present embodiment, the first limiter 12da limits the relative position of the connector unit 22 when the thermal head 12 connects to the connector unit 22. This enables reliable connection of the thermal head 12 to the connector unit 22. The first limiter 12da can abut or be adjacent to the head bracket 20 to maintain connectors 12b and 22a parallel to each other to permit smooth inserting and removing.

In the present embodiment, the pair of concaves 12e and the pair of convexes 20a hold the thermal head 12 before moving the connector unit 22. This enables reliable connection of the thermal head 12 to the connector unit 22 during connection and disconnection of the thermal head 12 and the connector unit 22.

In the present embodiment, the pair of concaves 12e and the pair of convexes 20a hold the thermal head 12 when the user attaches the thermal head 12 to the connector unit 22.

This makes the attachment of the thermal head 12 to the connector unit 22 easier.

In the present embodiment, the gear mechanism moves the connector unit 22.

This can minimize the rotary motion of the head cover 21 required for connection or disconnection of the thermal head 12 and the connector unit 22. This can reduce burden on a user's operation required for connection or disconnection of the thermal head 12 and the connector unit 22.

This can minimize a space required to move the head cover 21 as well. This enables easy replacement of the thermal head 12 without increasing the printer 1 in size.

In the present embodiment, engagement of the pair of engaging parts 21a with the pair of protrusions 20b locks the head cover 21 at the shielding position. This can prevent unexpected cancellation of the connection of the thermal head 12 to the connector unit 22.

In the present embodiment, the head cover 21 at the non-shielding position and the printer cover 3 define a space there between. Since the connector unit 22 is exposed through this space, the user can recognize the connector unit from the outside of the printer 1.

This allows a user to move the head cover 21 to the non-shielding position and then attach the thermal head 12 to the head bracket 20 easily. This facilitates the user attachment or detachment of the thermal head 12 and the connector unit 22.

In the present embodiment, the connector unit 22 moves in parallel with the thermal head 12. This allows the user to connect or disconnect the thermal head 12 and the connector unit 22 easily without breaking the thermal head 12 and the connector unit 22.

As discussed above, print medium P includes a liner PM and labels PL. The height of the liner PM by itself differs from the height of the liner PM and labels PL together. This difference in height can cause movement (rattling) of the thermal head 12 relative to the platen roller 10 as the print medium P moves between the platen roller 10 and the thermal head 12. The head bracket 20 (which holds thermal head 12) is permitted to move relative to the platen roller 10 to accommodate the effect of this height difference. As shown in FIGS. 8 and 10, one or more springs 20s are provided on the backside of head bracket 20. The springs 20s extend between the head bracket 20 and a fixed support member (not shown) of the printer body and serve to bias (or urge) the head bracket 20 (and thus thermal head 12) towards the platen roller 10 while still permitting movement of the head bracket 20. As mentioned above, the size d1 of the second limiter 12db is substantially the same as the size d2 of the notch 22ba in the front-rear direction (FR-RR direction) and accordingly, the thermal head 12 and the connector unit 22 move together in response to the bias force from the springs 20s. Thus, the design of the thermal head 12 permits the thermal head 12, the head bracket 20, and the connector unit 22 to be fixed to one another and move together with one another. The also improves the integrity and durability of the connection between connector 12b and connector 22a. Other types of bias members may be used.

### (6) MODIFIED EXAMPLES

The following describes modified examples of the present embodiment.

### Modified Example 1

The following describes Modified Example 1. Modified Example 1 describes a preferable example of a ratio of the number of gear teeth of the pair of gears 21b to the pair of gears 23 (hereinafter called a “gear ratio”).

A larger gear ratio of the pair of gears 21b to the pair of gears 23 is preferred.

Such a larger gear ratio means a smaller amount of rotation of the head cover 21 required for connection or disconnection of the thermal head 12 and the connector unit 22. Such a larger gear ratio means a smaller force required to rotate the head cover 21.

That is, a larger gear ratio can reduce the burden on user's operation to connect or disconnect the thermal head 12 and the connector unit 22.

### Modified Example 2

The following describes Modified Example 2. In Modified Example 2, the connector unit 22 moves in response to the operation performed to an operation member different from the head cover 21.

In one example, the printer cover 3 has a lever (one example of the operation member).

The lever has a pair of gears. The pair of gears of the lever engages with the pair of gears 23 (FIG. 2). Such engagement converts the rotary motion of the lever into the motion of the connector unit 22 in the up-down direction (UP-LO direction) via the pair of gears 23.

That is, a gear mechanism is made up of the pair of gears of the lever and the pair of gears 23, and this gear mechanism is a moving mechanism to join with the connector unit 22. This moving mechanism moves the connector unit 22 in response to the rotating operation of the lever.

In Modified Example 2, the head cover 21 can be omitted.

### Modified Example 3

The following describes Modified Example 3. In Modified Example 3, the connector unit 22 moves with a motion different from the rotating motion.

In one example, the following describes a head cover 21 in FIG. 2 that is slidable in the up-down direction (UP-LO direction) relative to the printer cover 3.

In FIG. 2, the head bracket 20 has a guide groove at each end in the width direction (LH-RH direction), and the guide grooves extend in the up-down direction (UP-LO direction).

The head cover 21 has a joint part and an engagement part.

The joint part joins the connector unit 22.

The engagement part is located at ends of the head cover 21 in the width (LH-RH direction). The engagement part engages with the guide grooves.

That is, the head cover 21 in Modified Example 3 joins the connector unit 22 and engages with the printer cover 3 slidably.

In order to connect the thermal head 12 to the connector unit 22, a user slides the head cover 21 downward (LO) until the head cover 21 is located at the lower end of the guide grooves (one example of the non-shielding position).

Next, the user slides the head cover 21 upward (UP) until the head cover 21 is located at the upper end of the guide grooves (one example of the shielding position). This moves the connector unit 22 upward (UP) (in the direction toward the thermal head 12).

When the thermal head 12 is to be disconnected from the connector unit 22, the user slides the head cover 21 to the non-shielding position.

As the head cover 21 slides, the connector unit 22 moves downward (LO) (i.e., in the direction away from the thermal head 12).

This disconnects the thermal head 12 from the connector unit 22.

As described above, in Modified Example 3, the sliding operation of the head cover 21 results in connection or disconnection of the thermal head 12 and the connector unit 22.

In Modified Example 3, the pair of gears 21b and the pair of gears 23 can be omitted.

### Modified Example 4

The following describes Modified Example 4. Modified Example 4 describes an example, in which a connecting board moves with the rotation of the head cover, the connecting board being connectable to the thermal head.

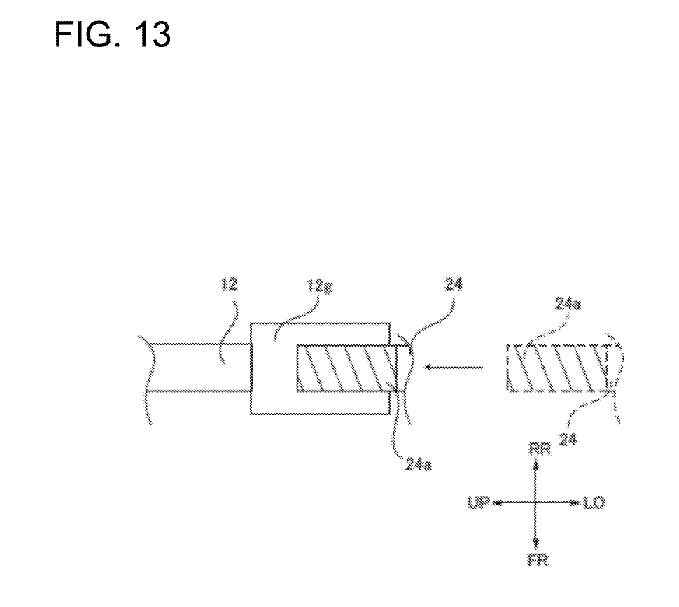

FIG. 13 schematically shows Modified Example 4 of the present embodiment.

As shown in FIG. 13, a connector 12g (one example of the first connector) is attached to the thermal head 12 of Modified Example 4.

The connecting board 24 (one example of the connecting part) can connect to the connector 12g. The connecting board 24 includes a connector 24a (one example of the second connector). The connector 24a protrudes upward (UP) from the connecting board 24.

The connecting board 24 converts the rotary motion of the head cover 21 into the motion of the connecting board 24 in the up-down direction (UP-LO direction) due to a configuration similar to that of FIG. 2, for example.

The rotation of the head cover 21 moves the connecting board 24 in the up-down direction (UP-LO direction). This results in connection or disconnection of the connecting board 24 and the connector 12g.

That is, the head cover 21 of Modified Example 4 moves the connecting board 24.

As described above, when the user moves the head cover 21 of Modified Example 4, a connection or disconnection of the connector 12g as the connecting terminal of the thermal head 12 and the connector 24a as the connecting terminal of the printer body occurs. This enables connection or disconnection of the thermal head 12 and the connecting board 24 without touching the thermal head 12 and the connecting board 24. This allows the user to connect or disconnect the thermal head 12 and the connecting board 24.

### Modified Example 5

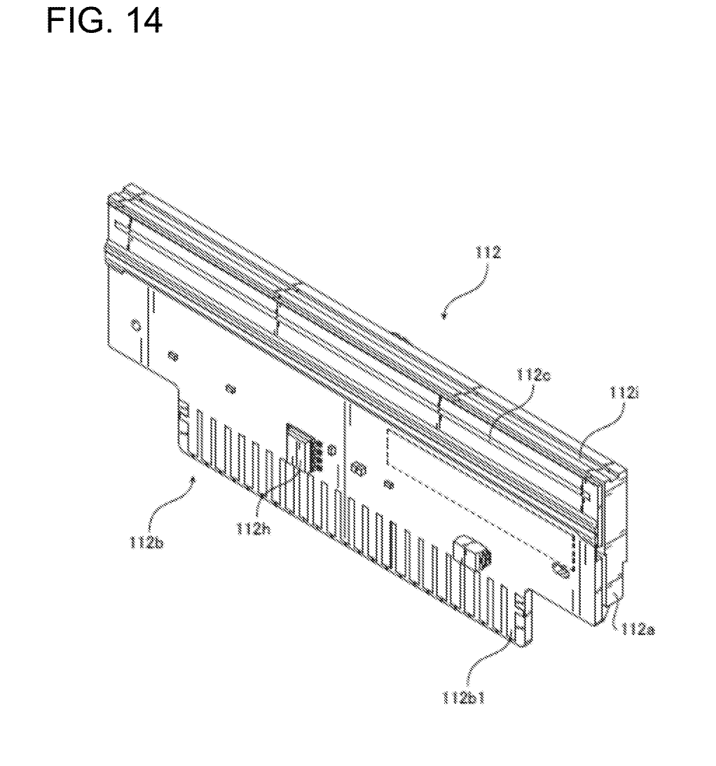

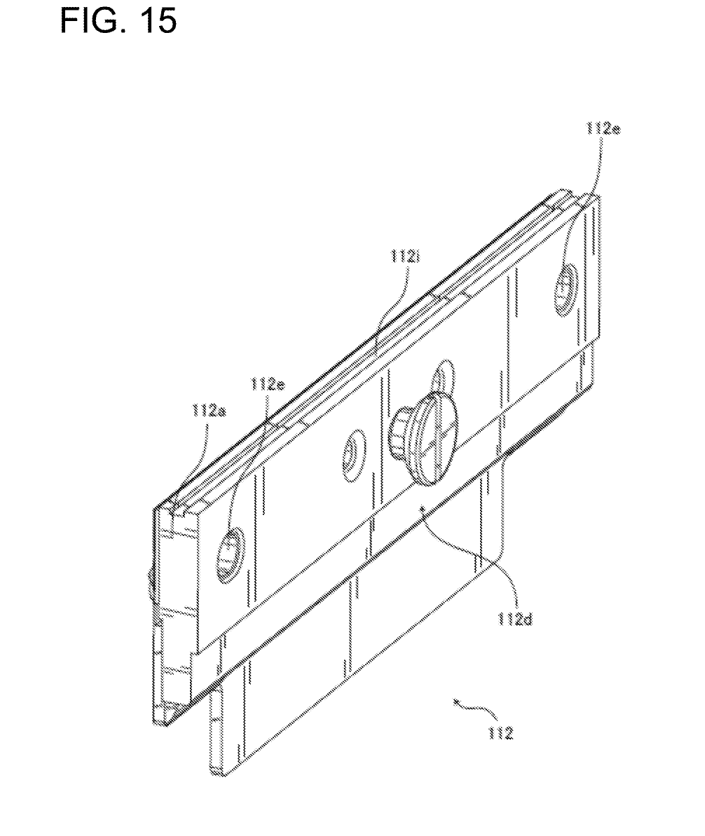

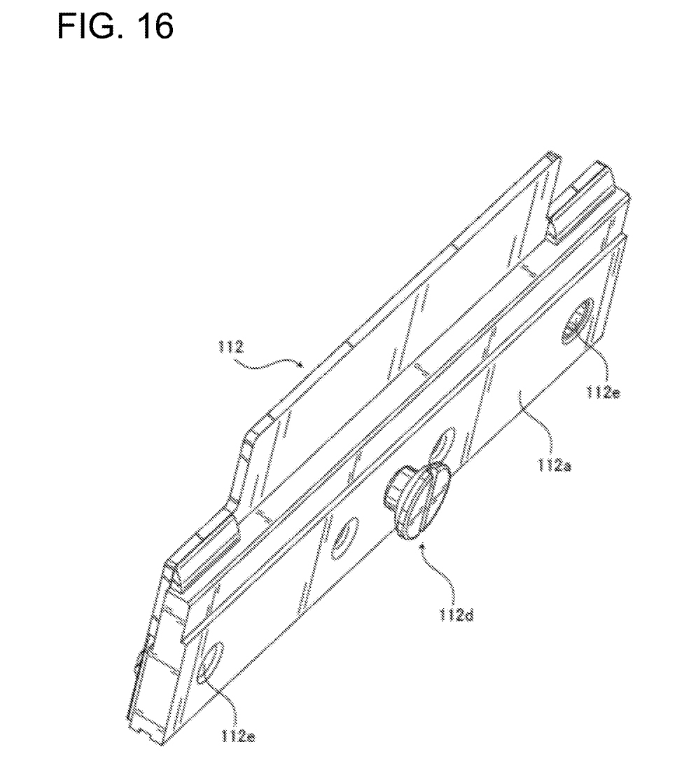

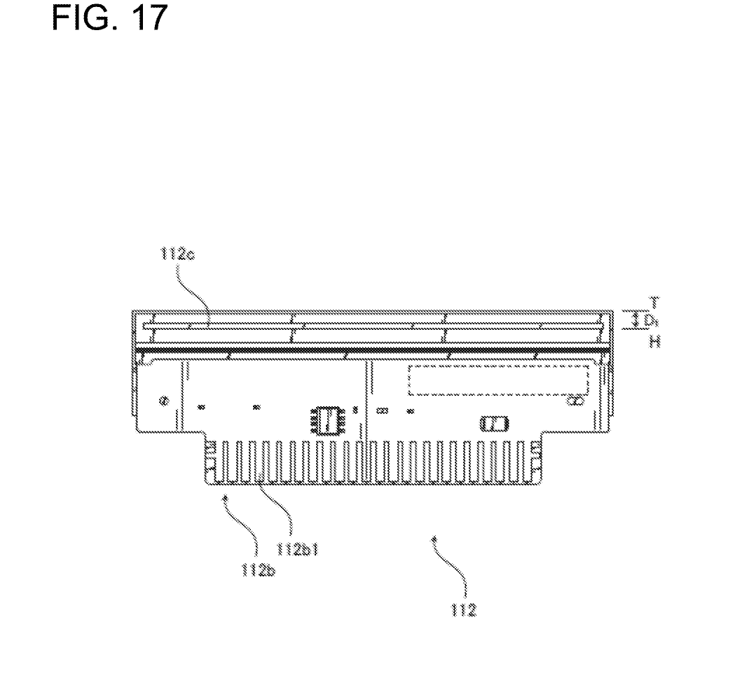

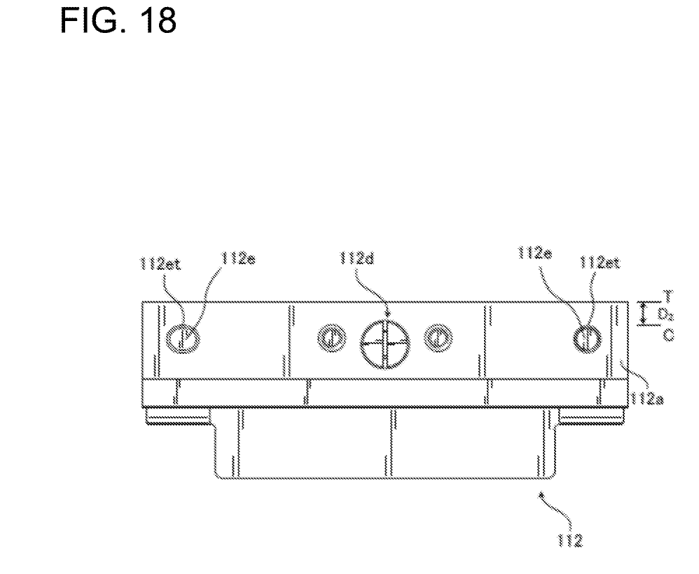

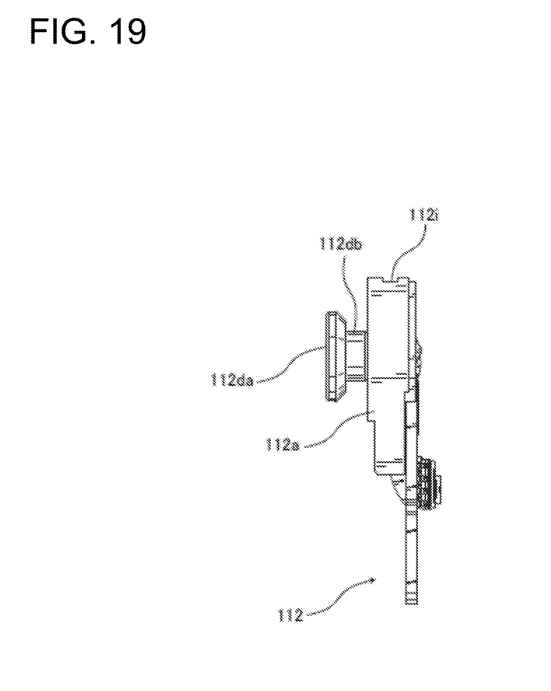

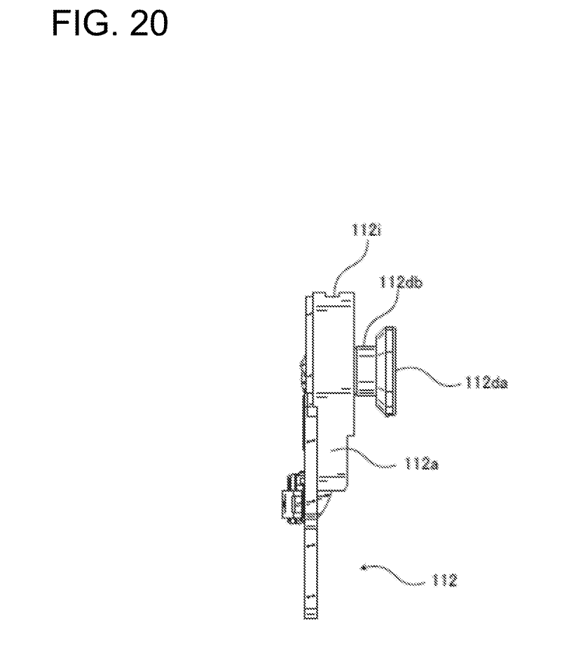

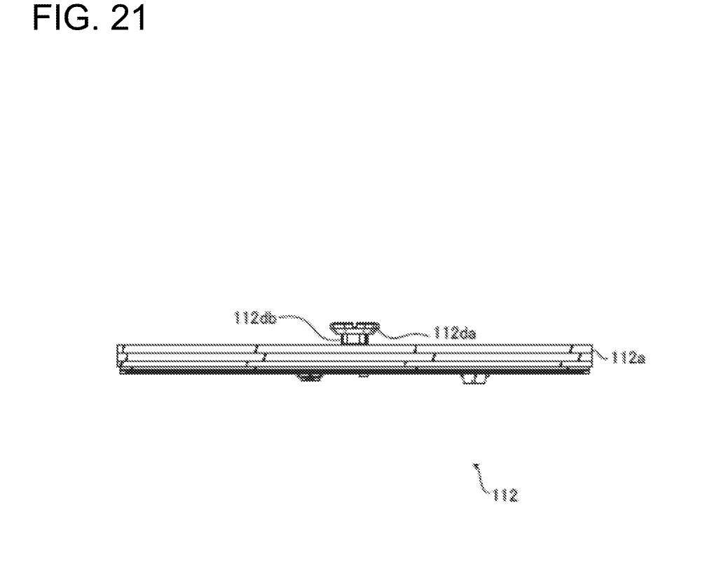

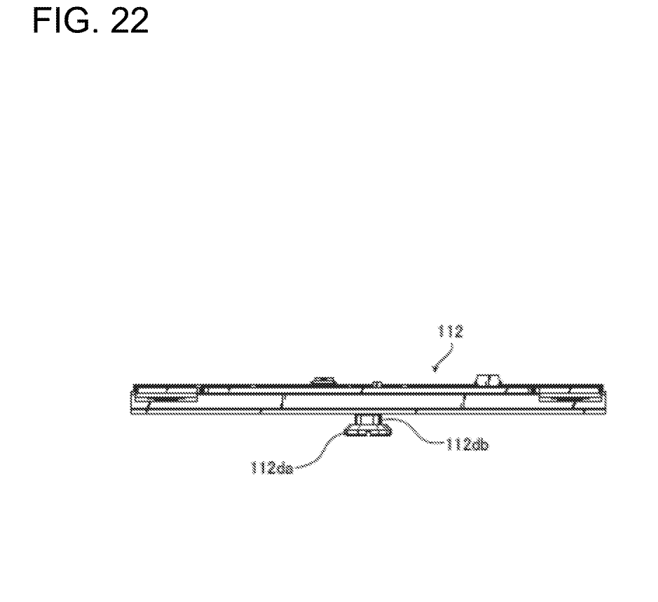

FIGS. 14 to 22 illustrate another embodiment. This example comprises a thermal head 112, and includes a thermal head body 112a, a male connector 112b, a heater element 112c, a connector unit limiter 112d, a first limiter 112da which forms a head portion, a second limiter 112db which forms a narrow portion, concaves 112e, and electronic circuits such as integrated circuits 112h. This embodiment is similar to the thermal head 12. In this embodiment, the concaves 112e and the corresponding protrusion portions (such as portions 20a) help tentatively hold the thermal head when the thermal head is first inserted by a user. But the thermal head may still tend to fall forward. The connector unit limiter 112d helps prevent the thermal head from falling forward. The second limiter 112db forms a narrow portion configured to mate with a portion which extends from the female electrical connector. In this embodiment, the connector 112b is made up of twenty four copper electrical contacts 112b1 (only a few of which are labeled in the figures).

At least a portion of the thermal head body 112a, such as the portion containing concaves 112e and the portion behind the heater element 112c, is made of a material which readily radiates heat, such as aluminum, aluminum alloy, or other metal that readily radiates heat. The lower edge of heater element 112c is aligned along a line H which is spaced from a top (or upper) edge T by a distance D₁. The top portion 112et of concaves 112e are aligned along a line C which is spaced from top edge T by a distance D₂. The distance D₂ is greater than the distance D₁ (by, for example, a 1 mm, or 2 mm or more). This ensures that the concaves 112e are not directly behind the heater element 112c, and thus provides heat-radiating material behind the heater element 112c, which helps maintain the temperature of the heater element 112c low, which helps maintain print quality.

In this embodiment, one of the concaves 112e is cylindrical to match the cylindrical shape of a projection 20a and one of the concaves is oval to allow for dimensional variation. However, in other embodiments, the concaves are other shapes, such as rectangular, or simple depressions or lack of material and may not match the shape of the projections.

A groove 112i is provided on the top surface of thermal head body 112a and is configured to be gripped by a finger or fingernail (or thumb or thumbnail) via notch(es) 20i in head bracket 20 to allow a user to easily remove the thermal head 112 from head bracket 20. The notches 20i thus permit the groove 112i to be at least partially exposed to the user when the thermal head 112 is installed in the head bracket 20. Many other types of indentations or projections may be used instead of groove 112i.

### OTHER MODIFIED EXAMPLES

The following describes other modified examples.

The above embodiments exemplify the print medium P having the liner PM and the labels PL, however the print medium P is not limited to this. The print medium P may be a label PL without a liner PM, for example.

The above embodiments exemplify printing with the thermal head, however printing is not limited to printing with a thermal head.

The present embodiment is applicable to printing using, for example, an ink ribbon as well.

The scope of the present invention is not limited to the embodiments described above. The above embodiments can be modified or changed without departing from the spirit and scope of the present invention. The above embodiments and modified examples can be combined. For example, a portion of one embodiment or example may be combined with one or more portions of another embodiment or example. Also, the above embodiments (or portion(s) thereof) and/or the above examples (or portion(s) thereof) may be combined with one or more features, components, arrangements, printers, thermal heads, and/or methods described in PCT patent applications PCT/JP2017/030681, PCT/JP2017/030686, PCT/JP2017/030687, and PCT/JP2017/030688, all filed on Aug. 28, 2017, listing Kazuyuki Hoshi as an inventor, designating the United States, and having Sato Holdings Kabushiki Kaisha as an applicant. The entire contents of all four of these PCT applications are incorporated herein by reference for the features, components, arrangements, printers, thermal heads, and methods set forth therein. For example, features, components, arrangements, printers, thermal heads, and methods of PCT patent applications PCT/JP2017/030681 and PCT/JP2017/030686 can be used in combination with features, components, arrangements, printers, thermal heads, and methods described above in connection with FIGS. 2, 8 and 10. As another example, the head cover and printer cover may be arranged as set forth in PCT/JP2017/030687 and/or the head cover or other operation member may be used as a label guide as set forth in PCT/JP2017/030688.

### REFERENCE SIGNS LIST

1: printer
2a: label ejection port
2b: liner ejection port
3: printer cover
6: container
10: platen roller
12: thermal head
12a: thermal head body
12aa: lower end
12b, 12g: connector
12c: heater element
12d: connector unit limiter
12da: first limiter
12db: second limiter
12e: concave
13: first assisting roller
14: second assisting roller
15: separator
16: first nip roller
17: second nip roller
20: head bracket
20a: convex
20b: protrusion
20d: head bracket body
20i: notches
21: head cover
21a: engaging part
21b: gear
22: connector unit
22a: connector
22b: abutting part
22ba: notch
22e: connector board
22f: engagement hole
23: gear
24: connecting board
24a: connector
112: thermal head
112a: thermal head body
112b: connector
112b1: electrical contacts
112c: heater element
112d: connector unit limiter
112da: first limiter
112db: second limiter
112e: concaves
112et: top portion
112h: electronic circuits
112i: groove

What is claimed is:

1. A thermal head for a printer, the thermal head comprising:
a heater element configured to print information; and
a male electrical connector configured to mate with a female electrical connector which moves in response to movement of a thermal head cover.

2. A thermal head, as set forth in claim 1, further comprising:
a connection unit limiter which projects from the thermal head to align the male electrical connector and the female electrical connector with each other.

3. A thermal head as set forth in claim 2, wherein the connection unit limiter comprises:
a first limiter configured to be adjacent to a head bracket; and
a second limiter configured to mate with a portion of the female electrical connector.

4. A thermal head as set forth in claim 2, wherein the connection unit limiter is screw-shaped in cross-section.

5. A thermal head as set forth in claim 2, wherein the connection unit limiter comprises a narrow portion and a larger head portion.

6. A thermal head as set forth in claim 1, further comprising:
two depressions configured to receive projections of a head bracket.

7. A thermal head as set forth in claim 6, wherein the two depressions are configured to receive the projections such that the thermal head is held.

8. A thermal head as set forth in claim 1, further comprising:
at least one depression configured to receive a projection of a head bracket.

9. A thermal head as set forth in claim 1, further comprising:
two depressions configured to receive projections of a head bracket to restrict the thermal head from moving in a feeding direction of a print medium, a top portion of the two depressions being spaced from a top edge of the thermal head farther than the heater element is spaced from the top edge of the thermal head.

10. A thermal head as set forth in claim 1, further comprising a groove on a top surface of the thermal head configured to be gripped by at least one of a finger, fingernail, thumb or thumbnail.

11. A thermal head as set forth in claim 1, wherein a top surface of the thermal head is shaped to be gripped by at least one of a finger, fingernail, thumb or thumbnail.

12. A thermal head for a printer, the thermal head comprising:
a heater element configured to print information; and
a female electrical connecter configured to mate with a male electrical connector which moves in response to movement of a thermal head cover.

13. A thermal head as set forth in claim 12, further comprising:
two depressions configured to receive projections of a head bracket.

14. A thermal head as set forth in claim 12, further comprising:
at least one depression configured to receive a projection of a head bracket.

15. A thermal head as set forth in claim 13, wherein the two depressions are configured to receive the projections such that the thermal head is held.

16. A thermal head for a printer, the thermal head comprising:
a heater element spaced from a top edge of the thermal head and configured to print information;
a male electrical connector configured to mate with a female electrical connector which moves in response to movement of a thermal head cover;
a connection unit limiter which projects from the thermal head, from a center portion of the thermal head in a width direction, the connection unit limiter comprising a head portion configured to be adjacent to a head bracket and a narrow portion configured to mate with a portion which extends from the female electrical connector; and
two depressions configured to receive projections of the head bracket to restrict the thermal head from moving in a feeding direction of a print medium, each of the two depressions being outboard of the connection unit limiter in the width direction, a top portion of the two depressions being spaced from the top edge of the thermal head farther than the heater element is spaced from the top edge of the thermal head.

17. A thermal head as set forth in claim 16, further comprising a groove on a top surface of the thermal head configured to be gripped by at least one of a finger, fingernail, thumb or thumbnail.

18. A thermal head as set forth in claim 16, wherein a top surface of the thermal head is shaped to be gripped by at least one of a finger, fingernail, thumb or thumbnail.

19. A thermal head as set forth in claim 16, further comprising two additional depressions configured to receive projections of a head bracket.
